(19) United States
(12) Patent Application Publication
(10) Pub. No.: US 2013/0092655 A1
(43) Pub. Date: Apr. 18, 2013

(54) METHOD FOR ETCHING AN EUV REFLECTIVE MULTI-MATERIAL LAYERS UTILIZED TO FORM A PHOTOMASK

(71) Applicants: Keven Yu, Union City, CA (US); Michael Grimbergen, Redwood City, CA (US); Madhavi Chadrachood, Sunnyvale, CA (US); Amitabh Sabharwal, San Jose, CA (US); Ajay Kumar, Cupertino, CA (US)

(72) Inventors: Keven Yu, Union City, CA (US); Michael Grimbergen, Redwood City, CA (US); Madhavi Chadrachood, Sunnyvale, CA (US); Amitabh Sabharwal, San Jose, CA (US); Ajay Kumar, Cupertino, CA (US)

(21) Appl. No.: 13/649,187

(22) Filed: Oct. 11, 2012

Related U.S. Application Data
(60) Provisional application No. 61/546,750, filed on Oct. 13, 2011.
(60) Provisional application No. 61/606,319, filed on Mar. 2, 2012.

(51) Int. Cl. B44C 1/22

(52) U.S. Cl. CPC B44C 1/227
USPC 216/41

(57) ABSTRACT

A method and apparatus for etching photomasks are provided herein. In one embodiment, a forming gas use utilized to remove a mask layer utilized film stack having a multi-material layer having at least two different materials. In another embodiment, a method of etching a multi-material layer disposed on a photomask includes providing a film stack in an etching chamber, the film stack having a multi-material layer having at least two different materials disposed therein partially exposed through a patterned layer, providing a gas mixture including at least one fluorine containing gas and an oxygen containing gas in to a processing chamber, supplying a RF power in the gas mixture to form a plasma, and etching the multi-material layer through the patterned layer.

### RELATED APPLICATIONS

This application claims benefit of U.S. Provisional Application Ser. No. 61/546,750 filed Oct. 13, 2011 (Attorney Docket No. APPM/16449L01) and U.S. Provisional Application Ser. No. 61/606,319, filed Mar. 2, 2012 (Attorney Docket No. APPM/16449L02), both of which are incorporated by reference in their entirety.

### BACKGROUND

1. Field

Embodiments of the present invention generally relate to a method for plasma an EUV reflective multi-material layers and, more specifically, to a method for etching an EUV reflective multi-material layers during photomask fabrication.

2. Description of the Related Art

In the manufacture of integrated circuits (IC), or chips, patterns representing different layers of the chip are created by a chip designer. A series of reusable masks, or photomasks, are created from these patterns in order to transfer the design of each chip layer onto a semiconductor substrate during the manufacturing process. Mask pattern generation systems use precision lasers or electron beams to image the design of each layer of the chip onto a respective mask. The masks are then used much like photographic negatives to transfer the circuit patterns for each layer onto a semiconductor substrate. These layers are built up using a sequence of processes and translate into the tiny transistors and electrical circuits that comprise each completed chip. Thus, any defects in the mask may be transferred to the chip, potentially adversely affecting performance. Defects that are severe enough may render the mask completely useless. Typically, a set of 15 to 30 masks is used to construct a chip and can be used repeatedly.

A photomask is typically a glass or a quartz substrate giving a film stack having multiple layers, including a light-absorbing layer, an opaque layer and a capping layer disposed thereon. When manufacturing the photomask layer, a photoresist layer is typically disposed on the film stack to facilitate transferring features into the film stack during the subsequently patterning processes. During the patterning process, the circuit design is written onto the photomask by exposing portions of the photoresist to extreme ultraviolet light or ultraviolet light, making the exposed portions soluble in a developing solution. The soluble portion of the resist is then removed, allowing the exposed underlying film stack be etched. The etch process removes the film stack from the photomask at locations where the resist was removed, i.e., the exposed film stack is removed.

With the shrink of critical dimensions (CD), present optical lithography is approaching a technological limit at the 45 nanometer (nm) technology node. Next generation lithography (NGL) is expected to replace the conventional optical lithography method, for example, in the 32 nm technology node and beyond. There are several NGL candidates, such as extreme ultraviolet (EUV) lithography (EUVL), electron projection lithography (EPL), ion projection lithography (IPL), nano-imprint, and X-ray lithography. Among these, EUVL is the most likely successor due to the fact that EUVL has most of the properties of optical lithography, which is more mature technology as compared with other NGL methods.

Accordingly, the film stack is being developed to have a new film scheme so as to work with the EUV technology to facilitate forming the photomask with desired features disposed thereon. The film stack may include multiple layers with different new materials to be etched to form the desired features. Imprecise etch process control may result in critical dimension (CD) bias, poor critical dimension (CD) uniformity, undesired cross sectional profile and etch critical dimension (CD) linearity and unwanted defects. It is believed that EUV technology may provide good CD uniformity, less etching bias, desired linearity, less line edge roughness, and high thickness uniformity and less defectivity.

In one etch process, known as dry etching, reactive ion etching, or plasma etching, a plasma is used to enhance a chemical reaction and etch the patterned film stack of the photomask. Undesirably, conventional etch processes often exhibit etch bias due to attack on the photoresist material utilized to pattern the film stack. As the photoresist or sidewall of the film stack is attacked during the etching process, the critical dimension of patterned resist is not accurately transferred to the film stack. Thus, conventional etch processes may not produce acceptable results for photomasks having critical dimensions less than about 5 μm. This results in non-uniformity of the etched features of the photomask and correspondingly diminishes the ability to produce features for devices having small critical dimensions using the photomask. As the critical dimensions of photomask continue to shrink, the importance of etch uniformity increases. Thus, a etch process having high etch uniformity to the film stack disposed on the photomask for EUV technology is highly desirable.

Thus, there is a need for an improved etch process for forming a photomask for EUV technology.

### SUMMARY

Embodiments of the present invention generally provide a method and apparatus for etching photomasks for EUV technologies. Embodiments of the present invention also generally relate to photomask manufacture technology for binary, PSM, OMOG and EUV Lithography. Embodiments of the present invention also generally relate to a method of plasma removal of resist after Cr, MoSi, OMOG, EUV, ARC and absorber etching, and also for EUV light shield and PSM applications.

In one embodiment, a method of etching a multi-material layer disposed on a photomask includes transferring a film stack into an etching chamber, the film stack having a multi-material layer having at least two different materials disposed therein partially exposed through a patterned layer, providing a gas mixture including at least one fluorine containing gas and an oxygen containing gas in to a processing chamber, supplying RF power to form a plasma from the gas mixture, and etching the multi-material layer through the patterned layer in the presence of the plasma.

In another embodiment, a method of etching a multi-material layer disposed on a photomask includes transferring a film stack into an etching chamber, the film stack having a multi-material layer having at least one molybdenum layer and one silicon layer disposed therein partially exposed through a patterned layer, providing a gas mixture including at least one fluorine containing gas and an oxygen containing gas in to a processing chamber, supplying RF power to form a plasma from the gas mixture, and etching the multi-material layer through a patterned layer in the presence of the plasma.

In yet another embodiment, a method of etching a multi-material layer disposed on a photomask includes transferring a film stack into an etching chamber, the film stack having a multi-material layer having at least one molybdenum layer and one silicon layer disposed therein partially exposed through a patterned layer, wherein the patterned layer includes a patterned photoresist layer disposed on a absorber layer, providing a gas mixture including at least one fluorine containing gas, an oxygen containing gas and a chlorine containing gas in to a processing chamber, supplying a RF power in the gas mixture to form a plasma from the gas mixture, and etching the multi-material layer through a patterned layer in the presence of the plasma.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A-1C depict one embodiment of a sequence for manufacturing an EUV photomask in accordance with one embodiment of the invention;

FIG. 2 depicts a schematic cross-sectional view of a processing chamber that may be utilized to fabricate a photomask in accordance with one embodiment of the present invention;

FIG. 3 depicts a flow diagram of a method for manufacturing a photomask in accordance with one embodiment of the present invention; and

Appendix provides additional information relating to the invention.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention provides a method and apparatus for manufacturing a photomask substrate. More specifically, the invention relates to methods of etching of a reflective multi-material layer disposed on a photomask substrate with improved etching control.

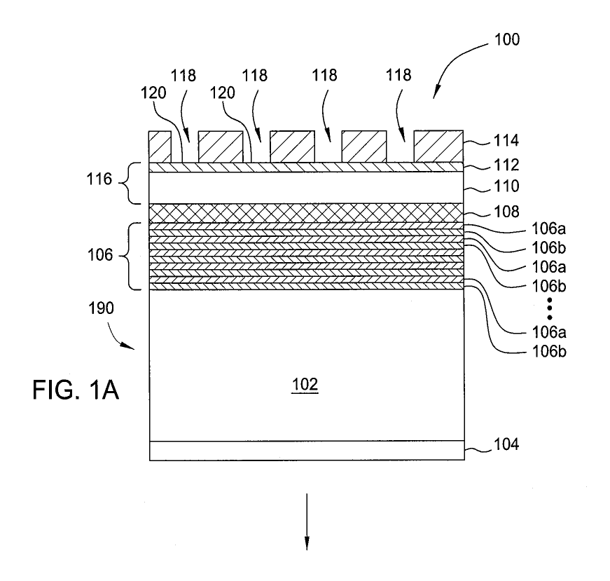

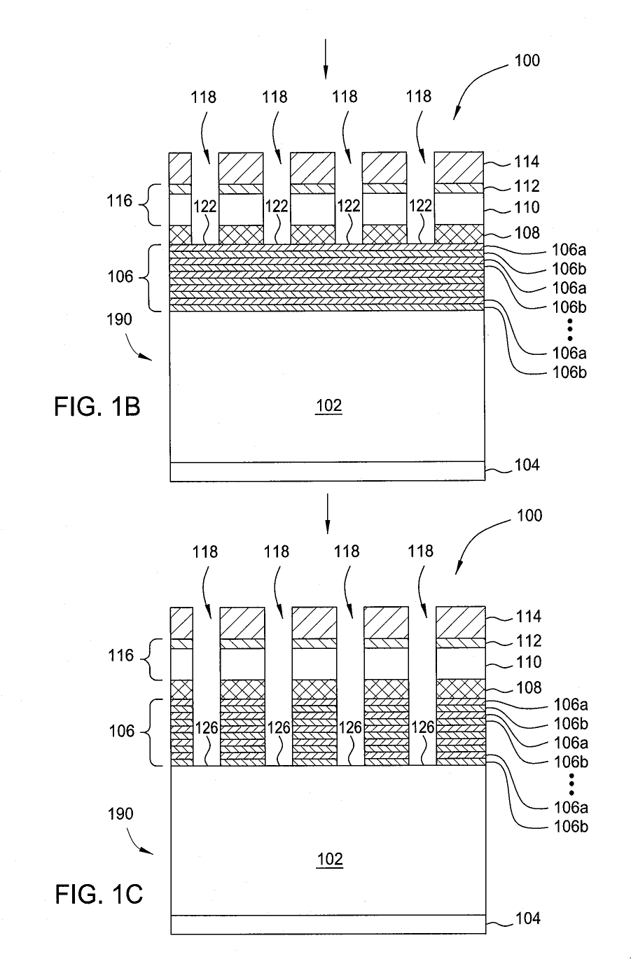

FIGS. 1A-1C depicts a process sequence for manufacturing a photomask 190. The photomask 190 includes a film stack 100 disposed on a photomask 190 that may be utilized to form desired features 118 on the photomask 190. As the exemplary embodiment depicted in FIG. 1A, the photomask substrate 102 may be a quartz substrate (i.e., low thermal expansion silicon dioxide (SiO₂)) layer. The photomask substrate 102 has a rectangular shape having sides between about 5 inches to about 9 inches in length. The photomask substrate 102 may be between about 0.15 inches and about 0.25 inches thick. In one embodiment, the photomask substrate 102 is about 0.25 inches thick. An optional chromium containing layer 104, such as a chromium nitride (CrN) layer may be disposed to a backside of the photomask substrate 102 as needed.

An EUV reflective multi-material layer 106 is disposed on the photomask substrate 102. The reflective multi-material layer 106 may include at least one molybdenum layer 106a and a silicon layer 106b. Although the embodiment depicted in FIG. 1A shows five pairs of molybdenum layer 106a and a silicon layer 106b (alternating molybdenum layers 106a and the silicon layers 106b repeatedly formed on the photomask substrate 102), it is noted that number of molybdenum layers 106a and the silicon layers 106b may be varied based on different process needs. In one particular embodiment, forty pairs of molybdenum layers 106a and the silicon layers 106b may be deposited to form the reflective multi-material layer 106. In one embodiment, the thickness of each single molybdenum layer 106a may be controlled at between about 1 Å and about 10 Å, such as about 3 Å, and the thickness of the each single silicon layer 106b may be controlled at between about 1 Å and about 10 Å, such as about 4 Å. The reflective multi-material layer 106 may have a total thickness between about 10 Å and about 500 Å. The reflective multi-material layer 106 may have an EUV light reflectivity of up to 70% at 13.5 nm wavelength. The reflective multi-material layer 106 may have a total thickness between about 70 nm and about 140 nm.

Subsequently, a capping layer 108 is disposed on the reflective multi-material layer 106. The capping layer 108 may be fabricated by a metallic material, such as ruthenium (Ru) material, zirconium (Zr) material, or any other suitable material. In the embodiment depicted in FIG. 1A-1C, the capping layer 108 is a ruthenium (Ru) layer. The capping layer 108 has a thickness between about 1 nm and about 10 nm.

An absorber layer 116 may then be disposed on the capping layer 108. The absorb layer 116 is an opaque and light-shielding layer configured to absorb portion of the light generated during the lithography process. The absorber layer 116 may be in form of a single layer or a multi-layer structure, such as including a self-mask layer 112 disposed on a bulk absorber layer 110, as the embodiments depicted in FIGS. 1A-1C. In one embodiment, the absorber layer 116 has a total film thickness between about 50 nm and about 200 nm. The total thickness of the absorber layer 116 advantageously facilitates meeting the strict overall etch profile tolerance for EUV masks in sub-45 nm technology node applications.

In one embodiment, the bulk absorber layer 110 may comprise tantalum-based materials with essentially no oxygen, for example tantalum silicide based materials, such as TaSi, nitrogenized tantalum boride-based materials, such as TaBN, and tantalum nitride-based materials, such as TaN. The self-mask layer 112 may be fabricated from a tantalum and oxygen-based materials. The composition of the self-mask layer 112 corresponds to the composition of the bulk absorber layer 110 and may comprise oxidized and nitrogenized tantalum and silicon based materials, such as TaSiON, when the bulk absorber layer 110 comprises TaSi or TaSiN; tantalum boron oxide based materials, such as TaBO, when the bulk absorber layer 110 comprises TaBN; and oxidized and nitrogenized tantalum-based materials, such as TaON, when the bulk absorber layer 110 comprises TaN.

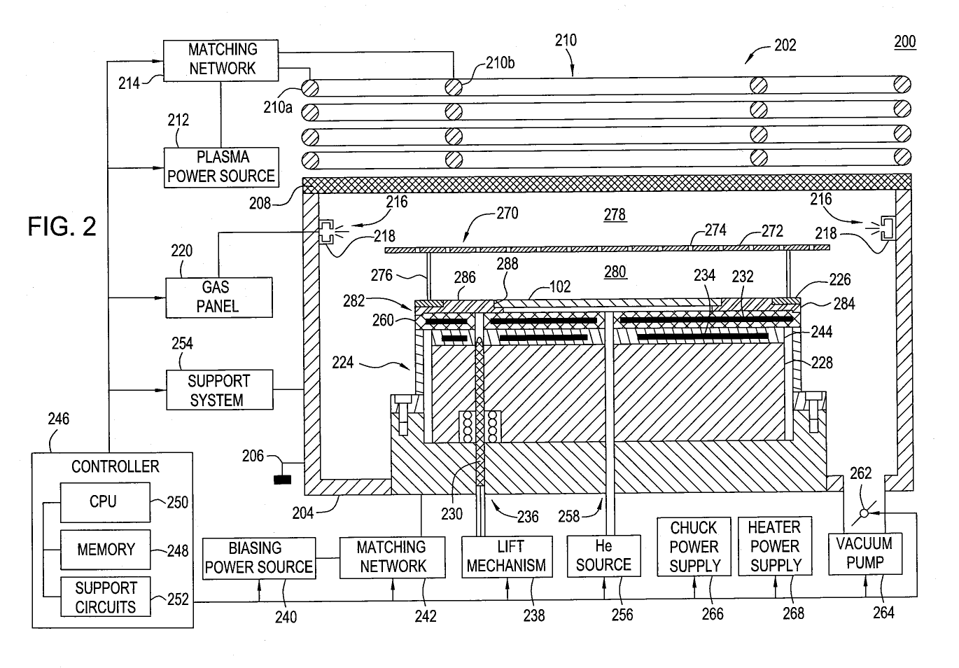

A patterned photoresist layer 114 is then formed over the absorber layer 116 having openings 118 formed therein that expose portions 120 of the absorber layer 116 for etching. The openings 118 of the photoresist layer 114 may be patterned by a gas mixture including at least a H₂ gas and a N₂ gas. During patterning of the photoresist layer 114, a RF source power may be supplied to a coil formed in a processing chamber, such as the etch reactor 200 which will be further described below with referenced to FIG. 2, with or without applying a bas RF power to etch thereof forming the openings 118 in the photoresist layer 114. The photoresist layer 114 may comprise any suitable photosensitive resist materials, such as an e-beam resist (for example, a chemically amplified resist (CAR)), and deposited and patterned in any suitable manner. The photoresist layer may be deposited to a thickness between about 100 nm and about 1000 nm.

Next, the photomask substrate 102 is transferred to an etching processing chamber, such as the etch reactor 200 which will be further described below with referenced to FIG. 2, to perform an etching process. The etching process is performed to etch the absorb layer 116 and the capping layer 108 exposed through the opening 118 defined by the photoresist layer 114. The etching process is performed to etch the absorb layer 116 and the capping layer 108 until the underlying surface 122 of the reflective multi-material layer 106 is exposed, as shown in FIG. 1B. The self-mask layer 112 and the bulk absorber layer 110 may be continuously etched using one process step, such as a single etchant chemistry, or separately etched by multiple steps in one or different etching processes as needed. The patterns from the photoresist layer 114 are then transferred into the absorber layer 116 and the capping layer 108 through the etching process.

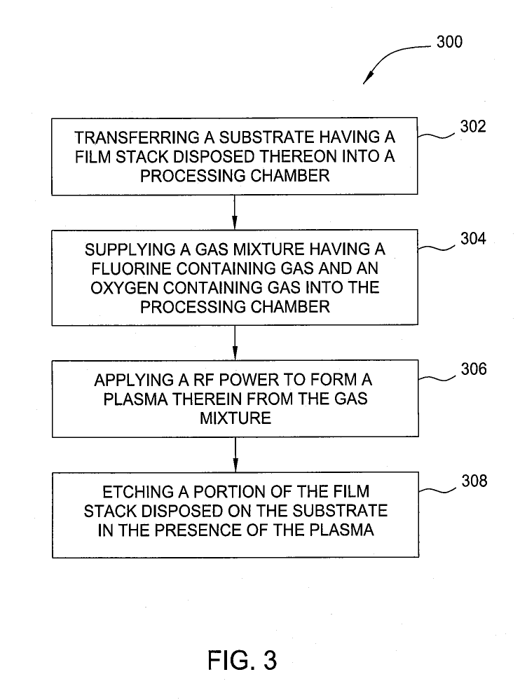

Subsequently, a reflective multi-material layer etching process is performed to etch the reflective multi-material layer 106. The reflective multi-material etching process uses an etching gas mixture configured to etch the reflective multi-material layer 106 until a desired depth of the reflective multi-material layer 106 is removed, or the underlying photomask substrate 102 is exposed. As the reflective multi-material layer 106 may include more than one types of the materials, the etching gas mixture as selected is configured to have high etching capability to etch different materials as well as maintaining high selectivity to the upper capping layer 108 and the absorber layer 116 so as to maintain desired sidewall profiles. Details of the reflective multi-material layer etching process will be further described below with referenced to FIG. 3.

FIG. 2 depicts a schematic diagram of an etch reactor 200. Suitable reactors that may be adapted for use with the teachings disclosed herein include, for example, the Decoupled Plasma Source (DPS®) II reactor, or the Tetra I, Tetra II, Tetra X Photomask etch systems, all of which are available from Applied Materials, Inc. of Santa Clara, Calif. The particular embodiment of the reactor 200 shown herein is provided for illustrative purposes and should not be used to limit the scope of the invention. It is contemplated that the invention may be utilized in other plasma processing chambers, including those from other manufacturers.

The reactor 200 generally comprises a process chamber 202 having a substrate pedestal 224 within a conductive body (wall) 204, and a controller 246. The chamber 202 has a substantially flat dielectric ceiling or lid 208. Other modifications of the chamber 202 may have other types of ceilings, e.g., a dome-shaped ceiling. An antenna 210 is disposed above the ceiling 208 and comprises one or more inductive coil elements that may be selectively controlled (two co-axial elements 210a and 210b are shown in FIG. 2). The antenna 210 is coupled through a first matching network 214 to a plasma power source 212, which is typically capable of producing up to about 3000 W at a tunable frequency in a range from about 50 kHz to about 13.56 MHz.

The substrate pedestal (cathode) 224 is coupled through a second matching network 242 to a biasing power source 240. The biasing source 240 generally is a source of up to about 500 W at a frequency of approximately 13.56 MHz that is capable of producing either continuous or pulsed power. Alternatively, the biasing source 240 may be a DC or pulsed DC source.

In one embodiment, the substrate support pedestal 224 comprises an electrostatic chuck 260, which has at least one clamping electrode 232 and is controlled by a chuck power supply 266. In alternative embodiments, the substrate pedestal 224 may comprise substrate retention mechanisms such as a susceptor clamp ring, a mechanical chuck, and the like.

A reticle adapter 282 is used to secure the substrate (e.g., photomask or reticle), such as the substrate 102 depicted in FIGS. 1A-1C, onto the substrate support pedestal 224. The reticle adapter 282 generally includes a lower portion 284 that covers an upper surface of the pedestal 224 (for example, the electrostatic chuck 260) and a top portion 286 having an opening 288 that is sized and shaped to hold the substrate 102. The opening 288 is generally substantially centered with respect to the pedestal 224. The adapter 282 is generally formed from a single piece of etch resistant, high temperature resistant material such as polyimide ceramic or quartz. An edge ring 226 may cover and/or secure the adapter 282 to the pedestal 224.

A lift mechanism 238 is used to lower or raise the adapter 282 and the substrate 102 onto or off of the substrate support pedestal 224. The lift mechanism 238 comprises a plurality of lift pins 230 (one lift pin is shown) that travel through respective guide holes 236.

A gas panel 220 is coupled to the processing chamber 202 to provide process and/or other gases to the interior of the processing chamber 202. In the embodiment depicted in FIG. 2, the gas panel 220 is coupled to one or more inlets 216 formed in a channel 218 in the sidewall 204 of the chamber 202. It is contemplated that the one or more inlets 216 may be provided in other locations, for example, in the ceiling 208 of the processing chamber 202.

In one embodiment, the gas panel 220 is adapted to provide fluorinated process gas through the inlets 216 and into the interior of the body of the processing chamber 202. During processing, a plasma is formed from the process gas and maintained through inductive coupling of power from the plasma power source 212. The plasma may alternatively be formed remotely or ignited by other methods. In one embodiment, the process gas provided from the gas panel 220 includes at least a fluorinated gas and a carbon containing gas, an oxygen gas, and an chlorine containing gas. Examples of fluorinated and carbon containing gases include CHF₃ and CF₄. Other fluorinated gases may include one or more of C₂F, C₄F₆, C₃F₈ and C₅F₈. Examples of the oxygen containing gas include O₂, CO₂, CO, N₂O, NO₂, O₃, H₂O, and the like. Examples of the chlorine containing gas include Cl₂, CCl₄, CHCl₃, CH₂Cl₂, CH₃Cl, and the like.

The pressure in the processing chamber 202 is controlled using a throttle valve 262 and a vacuum pump 264. The vacuum pump 264 and throttle valve 262 are capable of maintaining chamber pressures in the range of about 1 to about 20 mTorr.

In operation, the temperature of the substrate 102 is controlled by stabilizing the temperature of the substrate pedestal 224. In one embodiment, the substrate support pedestal 224 comprises a resistive heater 244 and a heat sink 228. The resistive heater 244 generally comprises at least one heating element 234 and is regulated by a heater power supply 268.

An optional ion-radical shield 270 is disposed in the chamber 202 above the pedestal 224. The ion-radical shield 270 is electrically isolated from the chamber sidewalls 204 and the pedestal 224 such that no ground path from the plate to ground is provided. One embodiment of the ion-radical shield 270 comprises a substantially flat plate 272 and a plurality of legs 276 supporting the plate 272. The plate 272, which may be made of a variety of materials compatible with process needs, comprises one or more openings (apertures) 274 that define a desired open area in the plate 272. This open area controls the amount of ions that pass from a plasma formed in an upper process volume 278 of the process chamber 202 to a lower process volume 280 located between the ion-radical shield 270 and the substrate 102. The greater the open area, the more ions can pass through the ion-radical shield 270. As such, the size of the apertures 274 controls the ion density in volume 280, and the shield 270 serves as an ion filter. The plate 272 may also comprise a screen or a mesh wherein the open area of the screen or mesh corresponds to the desired open area provided by apertures 274. Alternatively, a combination of a plate and screen or mesh may also be used.

During processing, a potential develops on the surface of the plate 272 as a result of electron bombardment from the plasma. The potential attracts ions from the plasma, effectively filtering them from the plasma, while allowing neutral species, e.g., radicals, to pass through the apertures 274 of the plate 272. Thus, by reducing the amount of ions through the ion-radical shield 270, etching of the mask by neutral species or radicals can proceed in a more controlled manner. This reduces erosion of the resist as well as sputtering of the resist onto the sidewalls of the patterned material layer, thus resulting in improved etch bias and critical dimension uniformity.

FIG. 3 is a flow diagram of one embodiment of a method 300 for etching a reflective multi-material layer formed in a film stack disposed on a photomask, such as the reflective layer 106 formed in the film stack 100 depicted in FIGS. 1A-1C. Although the method 300 is described below with reference to a substrate utilized to fabricate a photomask, the method 300 may also be used to advantage in other photomask etching or any etching applications.

The method 300, which may be stored in computer readable form in the memory 248 of the controller 246 or other storage medium, begins at block 302 when the photomask substrate 102 is transferred to and placed on a support pedestal 224 disposed in an etch reactor, such as the etch reactor 200 depicted in FIG. 2. In one embodiment, the photomask substrate 102 rests in the opening 288 of the adapter 282. The photomask substrate 102, as described above, includes an optically transparent silicon based material, such as quartz (i.e., silicon dioxide (SiO₂)) layer having the reflective multi-material layer 106 disposed thereon having portions 122 of the reflective multi-material layer 106 exposed by the patterned photoresist layer 114, absorber layer 116 and the capping layer 108 readily for etching, as shown in FIG. 1B. The patterned photoresist layer 114, absorber layer 116 and the capping layer 108 may serve as a mask layer to protect some portion of the reflective multi-material layer 106 from being etched during the reflective multi-material layer etching process. As discussed above, the reflective multi-material layer 106 may include repeating pairs of molybdenum layers 106a and silicon layers 106b. The process of etching reflective multi-material layer 106 requires etching both of the molybdenum layer 106a and silicon layer 106b without attacking sidewalls of the absorber layer 116 and the capping layer 108 defined by the patterned photoresist layer 114. Therefore, a well selected gas mixture is chosen to etch the reflective multi-material layer 106 that has high capability for etching both molybdenum layer 106a and the silicon layer 106b while having high selectivity to the exposed sidewalls of the upper capping layer 108 and the absorber layer 116.

At block 304, an etching gas mixture is supplied into the etch reactor to etch the portions 122 of the reflective multi-material layer 106, as shown in FIG. 1B, exposed by the patterned photoresist layer 114 and the etched absorber layer 116 and the capping layer 108. In one embodiment, the etching gas mixture includes at least a fluorine containing gas. Suitable examples of the fluorine containing gas includes CF₄, CHF₃, CH₂F₂, C₂F₆, C₂F₈, SF₆, NF₃ and the like. As the fluorine element is an aggressive etchant, the fluorine containing gas supplied in the etching gas mixture is utilized to etch away portions of the reflective multi-material layer 106, including both molybdenum layer 106a and silicon layer 106b, to form desired features into the reflective multi-material layer 106.

Furthermore, an oxygen containing gas may also be supplied in the etching gas mixture. As the aggressive fluorine etchant may also attack the exposed sidewalls of the upper capping layer 108 and the absorber layer 116, the oxygen containing gas as supplied in the etching gas mixture may assist forming and depositing polymers on the sidewalls of the etched absorber layer 116, capping layer 108, and portions of the reflective multi-material layer 106. The deposited polymer may efficiently protect the sidewalls of the openings 118, preventing further attack during the aggressive reflective multi-material layer etching process. Suitable examples of the oxygen containing gas include O₂, N₂O, NO₂, O₃, CO, CO₂ and H₂O the like.

Additionally, a chlorine containing gas and/or a bromide containing gas may also be added to the etching gas mixture to assist etching the reflective multi-material layer 106 as needed. Examples of the chlorine-containing gas include Cl₂, HCl, SiCl₄, BCl₃, CCl₄, CHCl₃, CH₂Cl₂, CH₃Cl, combinations thereof and the like. Examples of the bromide containing gas include HBr, Br₂, combinations thereof, and the like. It is believed that bromide containing gas has relatively higher etching rate to the silicon layer 106b, as compared to molybdenum layer 106a. Accordingly, in the embodiment wherein the etching process is performed to selectively etch one layer at a time (e.g., when etching a molybdenum layer 106a, the underlying silicon layer 106b is used as an etch stop layer to provide an etch stop), chlorine and/or bromide containing gas may be alternatively used to individually etch the molybdenum layer 106a or the silicon layer 106b one at a time.

In an alternative embodiment, an inert gas may also be supplied into the etching gas mixture to assist the profile control as needed. Examples of the inert gas supplied in the gas mixture include Ar, He, Ne, Kr, Xe or the like.

In one embodiment, the fluorine containing gas and the oxygen containing gas supplied in the etching gas mixture may be maintained at a predetermined ratio to yield an efficient etching rate while sufficiently protecting the sidewall from undesired etching. In an exemplary embodiment, the fluorine containing gas and the oxygen containing gas is supplied in the etching gas mixture at a ratio between about 1 percent and about 20 percent. Alternatively, the fluorine containing gas may be supplied at a flow rate by volume between about 20 sccm and about 500 sccm. The oxygen containing gas may be supplied at a flow rate between about 1 sccm and about 100 sccm.

The chlorine containing gas may be supplied at a flow rate by volume at between about 20 sccm and about 500 sccm. The bromide containing gas may be supplied at a flow rate by volume at between about 10 sccm and about 100 sccm. The inert gas may be supplied at a flow rate between about 10 sccm and about 500 sccm. In the embodiment, wherein the chlorine containing gas or the bromide containing gas is supplied in the etching gas mixture along with the fluorine containing gas and the oxygen containing gas, the flow rate ratio of the fluorine containing gas to the chlorine and/or the bromide containing gas is controlled at between about 1:10 to about 1:10. The flow ratio of the oxygen containing gas to the total combined gas flow of the fluorine containing gas and/or the bromide containing gas is controlled at between about 1:1 to about 1:100.

At block 306, after the etching gas mixture is supplied into the etching gas mixture, a RF power is supplied to form a plasma from the gas mixture therein. The RF source power may be supplied at the gas mixture between about 100 Watts and about 3000 Watts and at a frequency between about 400 kHz and about 13.56 MHz. A bias power may also be supplied as needed. The bias power may be supplied at between about 10 Watts and about 300 Watts. In one embodiment, the RF source power may be pulsed with a duty cycle between about 10 to about 95 percent at a RF frequency between about 500 Hz and about 10 kHz.

Several process parameters may also be controlled while supplying the etching gas mixture to perform the etching process. The pressure of the processing chamber may be controlled at between about 0.5 milliTorr and about 500 milliTorr, such as between about 1 milliTorr and about 20 milliTorr.

At block 308, after the RF power is used to form a plasma from the etching gas mixture to form a plasma therein, the ions or aggressive radicals generated in the plasma may attack and react with the multi-material layer 106, thereby removing portions 122 of the multi-material layer 106 from the photomask substrate 102 unprotected by the patterned photoresist layer 114 and the upper absorber layer 116 and capping layer 108. The etching process is performed to etch the multi-material layer 106 until a desired depth of the multi-material layer 106 is removed or the underlying photomask substrate 102 is removed, as shown in FIG. 1C.

The end point of the etching process may be controlled by time mode or other suitable methods. For example, the etching process may be terminated after performing between about 50 seconds and about 500 seconds until the desired depth of the multi-material layer 106 is removed from the photomask substrate 102, or the underlying surface of the photomask substrate 102 is exposed, as shown in FIG. 1C. In this particular embodiment, the etching process may be performed between about 1 seconds and about 500 seconds. In another embodiment, the etching process may be terminated by determination from an endpoint detector, such as an OES detector or other suitable detector as needed.

After the desired profile and/or the structure of the film stack 100 is formed on the photomask substrate 102, the photoresist layer 114 may be removed accordingly. In one embodiment, the remaining resist and protective layer is removed by ashing. The removal process may be performed in-situ the etch reactor 200 in which the etching process performed at step 302-308 was performed. In the embodiment wherein the photoresist layer 114 is consumed and used up during the etching process, the ashing or photoresist layer removal process may be eliminated as needed.

Furthermore, prior to etching the film stack 100, the patterned photoresist layer

Thus, a method for etching a multi-material layer been provided that advantageously improves trench attributes and profile over conventional processes. Accordingly, the method of etching a multi-material layer described herein advantageously facilitates fabrication of photomasks suitable for patterning features having small critical dimensions in EUV technologies.

While the foregoing is directed to embodiments of the present invention, other and further embodiments of the invention may be devised without departing from the basic scope thereof, and the scope thereof is determined by the claims that follow.

1. A method of etching a multi-material layer disposed on a photomask, comprising:
transferring a film stack into an etching chamber, the film stack having a multi-material layer having at least two different materials disposed therein partially exposed through a patterned layer;
providing a gas mixture including at least one fluorine containing gas and an oxygen containing gas in to a processing chamber;
supplying a RF power to form a plasma from the gas mixture; and
etching the multi-material layer through the patterned layer in the presence of the plasma.

2. The method of claim 1, wherein multi-material layer includes at least one of a molybdenum layer and a silicon layer.

3. The method of claim 1, wherein the multi-material layer includes repeating pairs of molybdenum layers and silicon layers.

4. The method of claim 3, wherein the multi-material layer includes about 40 pairs of molybdenum layers and silicon layers.

5. The method of claim 1, wherein the fluorine containing gas is selected from a group consisting of CF₄, CHF₃, CH₂F₂, C₂F₆, C₂F₈, SF₆ and NF₃.

6. The method of claim 1, wherein the oxygen containing gas is selected from a group consisting of O₂, N₂O, NO₂, O₃, CO, CO₂ and H₂O.

7. The method of claim 1, wherein the gas mixture as provided further comprises a chlorine containing gas or a bromide containing gas.

8. The method of claim 7, wherein the chlorine containing gas is selected from a group consisting of Cl₂, HCl, SiCl₄, BCl₃, CCl₄, CHCl₃, CH₂Cl₂ and CH₃Cl and bromide containing gas is selected from a group consisting of HBr and Br₂.

9. The method of claim 1, wherein the film stack further comprises an absorber layer disposed on a capping layer formed on the multi-material layer.

10. The method of claim 9, wherein the patterned layer is a pattered photoresist layer disposed on the absorber layer.

11. The method of claim 1, wherein the fluorine containing gas and the oxygen containing gas supplied in the gas mixture is controlled at a flow ratio between about 1 percent and about 20 percent.

12. The method of claim 1, wherein the multi-material layer has a thickness between about 10 Å and about 500 Å.

13. The method of claim 2, wherein the gas mixture provided into the processing chamber further comprises an inert gas selected from the group consisting of Ar, He, Xe, Ne and Kr.

14. The method of claim 1, wherein supplying the RF power further comprises:
providing a plasma source power of between about 100 to about 3000 Watts.

15. The method of claim 1, wherein supplying the RF power further comprises:
providing a plasma bias power of between about 10 to about 300 Watts.

16. The method of claim 1, wherein providing the gas mixture further comprises:
forming a conformal oxygen containing protective layer on the patterned layer and sidewalls of the film stack as etched.

17. The method of claim 1, wherein the patterned layer is a photoresist layer patterned by supplying a gas mixture including at least a N₂ gas and a H₂ gas into the processing chamber.

18. The method of claim 17, wherein supplying the gas mixture further comprises:
delivering power to the processing chamber to generate a plasma by applying a source RF power to a coil with or without applying a bias RF power to the photomask.

19. A method of etching a multi-material layer disposed on a photomask, comprising:
transferring a film stack into an etching chamber, the film stack having a multi-material layer having at least one molybdenum layer and one silicon layer disposed therein partially exposed through a patterned layer;
providing a gas mixture including at least one fluorine containing gas and an oxygen containing gas in to a processing chamber;
supplying a RF power to form a plasma from the gas mixture; and
etching the multi-material layer through a patterned layer in the presence of the plasma.

20. The method of claim 19, wherein the multi-material layer includes about 40 repeating pairs of molybdenum layers and silicon layers.

21. The method of claim 19, wherein the gas mixture further comprises a chlorine containing gas or a bromide containing gas.

22. A method of etching a multi-material layer disposed on a photomask, comprising:
transferring a film stack into an etching chamber, the film stack having a multi-material layer having at least one molybdenum layer and one silicon layer disposed therein partially exposed through a patterned layer, wherein the patterned layer includes a patterned photoresist layer disposed on an absorber layer;
providing a gas mixture including at least one fluorine containing gas, an oxygen containing gas and a chlorine containing gas in to a processing chamber;
supplying a RF power to form a plasma from the gas mixture; and
etching the multi-material layer through a patterned layer in the presence of the plasma.
